(19) United States
(12) Patent Application Publication
(10) Pub. No.: US 2023/0170480 A1
(43) Pub. Date: Jun. 1, 2023

(54) Positive Electrode for Lithium Secondary Battery with Primer Layer Comprising Lithium Iron Phosphate

(71) Applicant: LG Energy Solution, Ltd., Seoul (KR)

(72) Inventors: Juryoun Kim, Daejeon (KR); Sung Soo Yoon, Daejeon (KR)

(73) Assignee: LG Energy Solution, Ltd., Seoul (KR)

(21) Appl. No.: 17/800,720

(22) PCT Filed: Feb. 14, 2022
(86) PCT No.: PCT/KR2022/002135

§ 371 Date: Aug. 18, 2022

(30) Foreign Application Priority Data
Feb. 22, 2021 (KR) 10-2021-0023120

(51) Int. Cl. H01M 4/58; H01M 10/0525; H01M 4/62; H01M 4/525; H01M 4/505; H01M 4/66

(52) U.S. Cl. CPC H01M 4/5825; H01M 10/0525; H01M 4/623; H01M 4/525; H01M 4/505; H01M 4/667; H01M 2004/028

(57) ABSTRACT

A positive electrode and a lithium secondary battery including the same are disclosed herein. In some embodiments, a positive electrode for a lithium secondary battery includes a positive electrode current collector, a primer coating layer formed on the positive electrode current collector, and a positive electrode active material layer formed on the primer coating layer, wherein the primer coating layer comprises lithium iron phosphate, a binder, a conductive material, and a dispersant, wherein the lithium iron phosphate is represented by the following Chemical Formula 1, wherein the dispersant is a hydrogenated nitrile butadiene rubber (HNBR), and wherein the hydrogenated nitrile butadiene rubber is contained in an amount of 0.4 to 2.0 wt % based on the weight of lithium iron phosphate

Li₁₊ₐFe₁₋ₛMₛ(PO_{4-b})X_{b} [Chemical Formula 1]
wherein,
M is at least one element selected from Co, Ni, Al, Mg, Ti and V,
X is F, S, or N, and
0≤s≤0.5; −0.5≤a≤+0.5; 0≤b≤0.1.

### CROSS-REFERENCE TO RELATED APPLICATION(S)

This application is a national phase entry under 35 U.S.C. § 371 of International Application No. PCT/KR2022/002135, filed on Feb. 14, 2022, which claims the benefit of Korean Patent Application No. 10-2021-0023120, filed on Feb. 22, 2021, the contents of which are incorporated by reference herein.

### TECHNICAL FIELD

The present disclosure relates to a positive electrode for a lithium secondary battery with a primer layer comprising lithium iron phosphate, and a lithium secondary battery comprising the same

### BACKGROUND

Due to the rapid increase in the use of fossil fuels, the demand for the use of alternative energy or clean energy is increasing, and as part thereof, the fields that are being studied most actively are the fields of power generation and power storage using electrochemistry.

At present, a secondary battery is a representative example of an electrochemical device that utilizes such electrochemical energy, and the range of use thereof tends to be gradually expanding.

Recently, along with the increase of the technological development and demand for mobile devices such as portable computers, portable phones, and cameras, the demand for secondary batteries has also sharply increased as an energy source. Among such secondary batteries is a lithium secondary battery exhibiting high charge/discharge characteristics and lifespan characteristics and being environmentally friendly, in which much research has been carried out and which is now commercialized and widely used.

Generally, the secondary battery is manufactured by impregnating a non-aqueous electrolyte solution into an electrode assembly comprising a positive electrode, a negative electrode, and a porous separator.

A carbon material is mainly used as a negative electrode active material of such a lithium secondary battery, and the use of lithium metal, sulfur compounds, etc. is also being considered. Also, as a positive electrode active material, lithium-containing cobalt oxide (LiCoO₂) is mainly used, and additionally, the use of lithium-containing manganese oxides such as LiMnO₂ having a layered crystal structure and LiMn₂O₄ having a spinel crystal structure, and lithium-containing nickel oxide (LiNiO₂) is being considered.

Moreover, in recent years, a lithium iron phosphate (LiFePO₄)-based compound having excellent thermal stability and being relatively inexpensive may be used as a positive electrode active material.

However, such this lithium iron phosphate has low energy density compared to other materials despite the advantages of excellent thermal stability and low price, and is therefore unsuitable for use in products requiring high energy density.

Further, since the lithium iron phosphate has a drawback of low electrical conductivity and ionic conductivity, it is applied by coating the surface of the lithium iron phosphate with carbon to improve electrical conductivity, and reducing the particle size to improve the ionic conductivity. However, in the case of reducing the particle size in this manner, the specific surface area increases and also aggregation occurs severely, which causes a lower dispersibility by the existing mixing process and a lower slurry solid content.

Therefore, there is an urgent need to develop a technology for a positive electrode that can have excellent characteristics as a whole without deteriorating special performance of the lithium secondary battery.

### DETAILED DESCRIPTION OF THE INVENTION

### Technical Problem

The present disclosure has been designed to solve the above-mentioned problems and other technical problems that have yet to be resolved.

Specifically, an object of the present disclosure is to provide a positive electrode for a lithium secondary battery which can realize high energy density while improving thermal stability, and at the same time, has excellent slurry characteristics for the production of positive electrodes, and a lithium secondary battery comprising the same.

### Technical Solution

In order to achieve the above object, according to one embodiment of the present disclosure, there is provided a positive electrode for a lithium secondary battery comprising:

a positive electrode current collector,

a primer coating layer formed on the positive electrode current collector, and

a positive electrode active material layer formed on the primer coating layer,

wherein the primer coating layer comprises lithium iron phosphate, a binder, a conductive material and a dispersant,

wherein the lithium iron phosphate is represented by the following Chemical Formula 1,

wherein the dispersant is a hydrogenated nitrile butadiene rubber (HNBR), and

wherein the hydrogenated nitrile butadiene rubber is present in an amount of 0.4 to 2.0 wt % based on the weight of lithium iron phosphate.

Li₁₊ₐFe₁₋ₛMₛ(PO_{4-b})X_{b} [Chemical Formula 1]

wherein,

M is at least one element selected from Co, Ni, Al, Mg, Ti and V,

X is F, S, or N, and

0 s≤0.5, −0.5≤a≤+0.5, and 0≤b≤0.1.

In one specific embodiment, the lithium iron phosphate may be composed of primary particles, or may be a mixture of the primary particles and secondary particles, wherein the secondary particles are aggregates of the primary particles.

The primary particles of the lithium iron phosphate may have an average diameter (D50) of 0.2 to 3.0 μm, and the secondary particles may have an average diameter (D50) of 7 to 25 μm.

The lithium iron phosphate may be in a state where the primary particles and/or the primary particles and the secondary particles in the mixture are carbon-coated.

In one specific embodiment, the content of acrylonitrile (AN) of the hydrogenated nitrile butadiene rubber may be 20 to 50 wt %, and the residual double bond (RDB) present in the hydrogenated nitrile butadiene rubber may be contained in an amount of 30% or less.

Further, the hydrogenated nitrile butadiene rubber may have a weight average molecular weight (Mw) of 10,000 to 250,000.

In one specific embodiment, the binder included in the primer coating layer may be polyvinylidene fluoride (PVdF) having a weight average molecular weight (Mw) of 500,000 to 1,200,000.

In one specific embodiment, the primer coating layer may be formed to a thickness of 1 to 5 μm, and the positive active material layer may be formed to a thickness of 50 to 300 μm.

In one specific embodiment, the positive electrode active material layer may include a lithium transition metal oxide as a positive electrode active material, and the lithium transition metal oxide may include at least one transition metal selected from the group consisting of Ni, Mn, and Co.

According to one embodiment of the present disclosure, there is provided a lithium secondary battery comprising the positive electrode for a lithium secondary battery.

### DETAILED DESCRIPTION OF THE EMBODIMENTS

Hereinafter, the present disclosure will be described in more detail for a better understanding of the present disclosure.

Terms or words used in the present specification and claims should not be construed as limited to ordinary or dictionary terms, and the present disclosure should be construed with meanings and concepts that are consistent with the technical idea of the present disclosure based on the principle that the inventors may appropriately define concepts of the terms to appropriately describe their own disclosure in the best way.

The technical terms provided herein is merely used for the purpose of describing particular embodiments only, and is not intended to be limiting of the present disclosure. The singular forms “a,” “an,” and “the” are intended to include the plural forms as well, unless the context clearly indicates otherwise.

As used herein, the terms “comprise”, “include” or “have”, etc. are intended to designate the existence of a specific feature, number, step, constitutional element and a combination thereof, but does not exclude the presence or addition of a different specific feature, number, step, constitutional element and a combination thereof step.

According to one embodiment of the present disclosure, there is provided a positive electrode for a lithium secondary battery comprising:

a positive electrode current collector,

a primer coating layer formed on the positive electrode current collector, and

a positive electrode active material layer formed on the primer coating layer,

wherein the primer coating layer comprises lithium iron phosphate, a binder, a conductive material and a dispersant,

wherein the lithium iron phosphate is represented by the following Chemical Formula 1,

wherein the dispersant is a hydrogenated nitrile butadiene rubber (HNBR), and

wherein the hydrogenated nitrile butadiene rubber is contained in an amount of 0.4 to 2.0 wt % based on the weight of lithium iron phosphate.

Li₁₊ₐFe₁₋ₛMₛ(PO_{4-b})X_{b} [Chemical Formula 1]

wherein,

M is at least one element selected from Co, Ni, Al, Mg, Ti and V,

X is F, S, or N, and

0 s≤0.5, −0.5≤a≤+0.5, and 0≤b≤0.1.

Here, the primer coating layer according to the present disclosure not only improves the adhesive force and electrical conductivity between the current collector and the positive electrode active material layer, but also is a layer applied to improve thermal stability, which is coated with a thin thickness different from that of a general positive electrode active material layer.

The primer coating layer for this purpose includes lithium iron phosphate, a binder, a conductive material, and a dispersant.

At this time, the lithium iron phosphate may be specifically LiFePO₄, and the lithium iron phosphate may be composed of primary particles or a mixture of the primary particles and secondary particles, wherein the secondary particles are aggregates of the primary particles.

That is, the lithium iron phosphate tends to aggregate, and is mainly used in the form of secondary particles, but according to the present disclosure, the ionic conductivity can be increased by using primary particles having a relatively small size.

At this time, the primary particles have an average diameter (D50) of 0.2 to 3.0 μm, specifically 0.2 to 1.0 μm, more specifically, 0.3 to 0.8 μm, and the secondary particles may have an average diameter (D50) of 2 to 10 μm, specifically 2 to 5 μm.

When the primary particle is too small outside the above range, the dispersibility is significantly reduced and aggregated, which makes it difficult to prepare the primary particles, and when the primary particle is too large, the difference from the secondary particles is small and the ionic conductivity may be lowered, which is not preferable. Even when the secondary particles are large, it is difficult to make the coating layer of the present disclosure uniform, and the ionic conductivity may be lowered, which is not preferable.

The average diameter (D50) means a particle diameter corresponding to a point of n % in the cumulative distribution of the number of particles relative to the particle diameter. That is, D50 is the particle diameter corresponding to a point of 50% in the cumulative distribution of the number of particles relative to the particle diameter.

The average diameter (D50) can be measured by using a laser diffraction method. Specifically, the powder to be measured is dispersed in a dispersion medium, and then introduced into a commercially available laser diffraction particle size analyzer (e.g., Mastersizer 3000 available from Malvern). When the particles pass through the laser beam, the diffraction pattern difference according to the particle size is measured to calculate the particle size distribution. The D50 can be measured by calculating the particle diameter corresponding a point of 50% in the cumulative distribution of the number of particles relative to the particle diameter in the analyzer.

Meanwhile, since the lithium iron phosphate oxide is used for the primer coating layer, it is preferably excellent in electrical conductivity. Thus, specifically, the primary particles and/or the primary particles and the secondary particles in the mixture of the lithium iron phosphate may be in a carbon-coated form.

In this manner, the lithium iron phosphate used for the primer coating layer has a small size, and has a problem that the dispersibility is greatly lowered only by the existing slurry mixing step and the solid content of the slurry is lowered, and thus improvement thereof is needed.

Therefore, the primer coating layer according to the present disclosure contains a dispersant together with the lithium iron phosphate, wherein the dispersant may be a hydrogenated nitrile butadiene rubber (HNBR).

The hydrogenated nitrile butadiene rubber (HNBR) means that the double bond originally contained in the nitrile butadiene rubber (NBR) is changed to a single bond by hydrogenating the nitrile butadiene rubber (NBR).

At this time, the content of acrylonitrile (AN) of the hydrogenated nitrile butadiene rubber may be 20 to 50 wt %, specifically 30 to 40 wt %, based on the total weight of the hydrogenated nitrile butadiene rubber (HNBR).

The acrylonitrile (AN) is polar, and the hydrogenated nitrile butadiene is non-polar. Thus, when the content of the acrylonitrile (AN) is too small or too large, dispersion in a solvent is not preferable when preparing the primer coating layer slurry.

Further, the residual double bond (RDB) present in the hydrogenated nitrile butadiene rubber may be 30% or less, specifically 20% or less, more specifically 10% or less, and most specifically 5% or less.

When the ratio of the residual double bond (RDB) is too large outside the above range, it may decrease the phase stability such as an increase in the possibility of side reactions with the electrolyte and gelation of the primer coating layer slurry, which is not preferable.

Further, the weight average molecular weight (Mw) of the hydrogenated nitrile butadiene rubber may be 10,000 to 250,000, specifically, 150,000 to 250,000.

Meanwhile, in order to minimize the problem of acting as a resistor while improving the dispersibility of the lithium iron phosphorus oxide, the hydrogenated nitrile butadiene rubber may be contained in an amount of 0.4 to 2.0 wt %, specifically, 0.5 to 1.0 wt % based on the weight of lithium iron phosphate.

When the hydrogenated nitrile butadiene rubber (HNBR) is contained in an amount of less than 0.4%, the surface area of lithium iron phosphate increases as the dispersed particle size decreases, and the dispersant does not sufficiently cover the surface of the increased lithium iron phosphate and thus, the slurry viscosity may increase significantly. When the content is more than 2.0%, an excess of the dispersant that is not adsorbed to the surface of the lithium iron phosphate may be present in the solvent, which may cause an increase in slurry viscosity.

Further, the primer coating layer includes a conductive material and a binder in addition to the lithium iron phosphate and the dispersant.

The conductive material is not particularly limited as long as it has conductivity without causing a chemical change in the corresponding battery, and for example, such as natural graphite or artificial graphite; carbon blacks such as carbon black, acetylene black, ketjen black, channel black, furnace black, lamp black, and thermal black; conductive fibers such as carbon fiber and metal fiber; metal powders such as carbon fluoride powder, aluminum powder, and nickel powder; conductive whiskey such as zinc oxide and potassium titanate; conductive metal oxides such as titanium oxide; conductive materials such as polyphenylene derivatives can be used.

Specific examples of commercially available conductive materials include acetylene black series products available from Chevron Chemical Company, Denka Singapore Private Limited, Gulf Oil Company, Ketjen black, EC series products available from Armak Company, Vulcan XC-72 available from Cabot Company and Super P available from Timcal, and the like.

Wherein, the content of the conductive material may be contained in an amount of 1 to 30 wt %, specifically 1 to 10 wt %, more specifically 1 to 5 wt % based on the total weight of the primer coating layer.

The binder is a type of binder known in the art, and is not limited as long as it is a type capable of improving the adhesive force of the electrode components. Examples thereof may be at least one selected from the group consisting of polyvinylidene fluoride, polyvinylidene fluoride-hexafluoropropylene, polyvinyl alcohol, carboxymethylcellulose (CMC), starch, hydroxypropyl cellulose, regenerated cellulose, polyvinylpyrrolidone, polytetrafluoroethylene, polyethylene, polypropylene, ethylene-propylene-diene polymer (EPDM), sulfonated EPDM, styrene-butadiene rubber, and fluorine rubber.

Specifically, the binder may be polyvinylidene fluoride (PVDF), and more specifically, polyvinylidene fluoride (PVDF) having a weight average molecular weight (Mw) of 500,000 to 1,200,000, specifically 700,000 to 1,000,000.

When the PVDF is contained, it can have the best phase stability with lithium iron phosphate, which is preferable.

When PVDF having a weight average molecular weight satisfying the above range is used, problems such as a decrease in solid content due to increase in the viscosity of the primer coating layer slurry do not occur while being able to have high adhesive force, which is preferable.

Wherein, the binder may be contained in an amount of 1 to 10 wt %, specifically 1 to 5 wt %, based on the total weight of the primer coating layer. When the content of the binder is too small outside the above range, the adhesive force is too low, making it difficult to maintain the coating layer, and when the content is too large, the resistance can be high.

The primer coating layer may be formed to a thickness of 1 to 20 μm, specifically 1 to 10 μm, and more specifically 1 to 5 μm.

When the primer coating layer is formed too thin outside the above range, it is not possible to sufficiently secure the thermal stability to be obtained by applying it according to the present disclosure, and when the primer coating layer is formed too thick, it acts like an active material layer rather than serving as a primer layer, whereby the volume of the positive electrode active material layer of the present disclosure is relatively reduced in the same volume, and therefore, the content of the positive electrode active material capable of increasing the energy density is reduced, which is not preferable in terms of secondary battery performance.

Meanwhile, the positive electrode active material layer formed on the primer coating layer may further include a positive electrode active material, and may further include the conductive material and the binder, and optionally, may further include an additive such as a filler.

In this case, examples of the conductive material and the binder are the same as described above, and may include the same or different materials from the conductive material and the binder included in the primer coating layer.

The positive active material may include a lithium transition metal oxide.

The lithium transition metal oxide may include, for example, a layered compound such as lithium cobalt oxide (LiCoO₂) or lithium nickel oxide (LiNiO₂) or a compound substituted with one or more transition metals; lithium manganese oxides such as chemical formulae Li₁₊ₓMn₂-xO₄ (where, x is 0˜0.33), LiMnO₃, LiMn₂O₃, LiMnO₂; lithium copper oxide (Li₂CuO₂); vanadium oxides such as LiV₃O₈; lithium iron oxides such as LiFe₃O₄, a Ni-site type lithium nickel oxide represented by chemical formula LiNi₁−xMxO₂ (where, M=at least one selected from Co, Mn, Al, Cu, Fe, Mg, B and Ga, and x=0.01˜0.3); lithium manganese composite oxide represented by chemical formulae LiMn₂−xMxO₂ (where, M=at least one selected from Co, Ni, Fe, Cr, Zn or Ta, and x=0.01˜0.1) or Li₂Mn₃MO₈ (where, M=at least one selected from Fe, Co, Ni, Cu or Zn); lithium manganese composite oxide having a spinel structure represented by LiNixMn₂₋ₓO₄, LiMn₂O₄ in which a portion of Li in the chemical formula is substituted with an alkaline earth metal ion, and the like.

Specifically, it may be a lithium transition metal oxide including at least one transition metal selected from the group consisting of Ni, Mn, and Co.

That is, according to the present disclosure, a positive electrode active material layer is formed on a primer coating layer containing lithium iron phosphate and a dispersing agent, and the positive electrode active material layer has a structure that does not contain lithium iron phosphate and includes lithium transition metal oxide as a positive electrode active material. If the positive electrode active material layer also uses lithium iron phosphate as the positive electrode active material, it can be used to a voltage drive range of 3.6V or less, wherein the energy density is lowered. Thus, in the present disclosure, the lithium iron phosphate is preferably included only in the primer coating layer.

The thickness of the positive active material layer is not limited, but, for example, may be formed to a thickness of 50 to 300 μm.

Meanwhile, the positive electrode current collector is not particularly limited as long as it has conductivity while not causing chemical changes to the battery, and for example, stainless steel, aluminum, nickel, titanium, calcined carbon, or aluminum or stainless steel having a surface treated with carbon, nickel, titanium, silver, and the like can be used. In addition, the first positive electrode current collector may have a thickness of 3 to 500 μm, and may have fine irregularities formed on the surface of the current collector to increase the adhesive force of the first positive electrode active material. For example, it may be used in various forms such as films, sheets, foils, nets, porous bodies, foams, and nonwoven fabrics.

Meanwhile, according to another embodiment of the present disclosure, there is provided a lithium secondary battery including the positive electrode for the lithium secondary battery.

The lithium secondary battery has a structure in which an electrode assembly including a negative electrode together with the positive electrode and a separator interposed between the positive electrode and the negative electrode is incorporated in a battery case together with a lithium non-aqueous electrolyte.

Other components and structures, etc. of such a lithium secondary battery are incorporated in the present disclosure with the contents known in the art, and, therefore, detailed description thereof will be omitted.

Hereinafter, preferred examples of the present disclosure, comparative examples for comparing them, and experimental examples for evaluating them are described. However, it will be obvious to those skilled in the art that these examples are for illustrative purposes only and various changes and modifications can be made without deviating from the scope and spirit of the present description, and it goes without saying that such modifications and modifications fall within the scope of the appended claims.

### Preparation Example 1

Primary particle LiFePO₄ (average diameter (D50): 0.5±0.15 μm), HNBR dispersant (Mw: 220,000±30,000, AN content: 35±3 wt %, RDB 0˜5%) were mixed in a weight ratio of 100:1 in a NMP solvent so that the solid content was 61%, thereby preparing a slurry.

### Preparation Example 2

Primary particles LiFePO₄ (average diameter (D50): 0.5±0.15 μm) were mixed in an NMP solvent so that the solid content was 61%%, thereby preparing a slurry.

### Experimental Example 1

The viscosity of the slurry prepared in Preparation Examples 1 and 2, and the average diameter (D50) of the LFP particles were measured, and shown in Table 1 below.

The average diameter of the LFP particles was measured by using a laser diffraction particle size analyzer (e.g., Mastersizer 3000 available from Malvern). When passing the particles through the laser beam, the diffraction pattern difference according to the particle size was measured to calculate the particle size distribution. The D50 was measured by calculating the particle diameter corresponding a point of 50% in the cumulative distribution of the number of particles relative to the particle diameter in the analyzer.

TABLE 1

| | Viscosity | LFP |
|---|---|---|
| | (cps) | PSD(D50) |
| Preparation | 1980 | 0.88 |
| Example 1 | | |
| Preparation | 9370 | 1.50 |
| Example 2 | | |

Referring to Table 1 above, it can be confirmed that due to the inclusion of the dispersant, LFP is well dispersed and there is less aggregation between particles, so that D50 is still similar to the size of the primary particles and the viscosity is not high, whereas Preparation Example 2 does not include the dispersant, the particle diameter and viscosity increase as the LFP aggregates with each other.

### Example 1

Primary particles LiFePO₄ (average diameter (D50): 0.5±0.15 μm), HNBR dispersant (Mw: 220,000±30,000, AN content: 35±3 wt %, RDB 0˜5%), a conductive material (carbon black) and a binder (PVDF, Mw: 700,000±50,000) were mixed at a weight ratio of 94.5:1:1.5:3 in an NMP solvent to prepare a primer slurry. At this time, the solid content was set to 45%.

The slurry was coated onto Al foil (thickness: 12 μm) to a thickness of 5 μm and dried to form a primer coating layer.

Then, LiCoO₂ as a positive electrode active material, a conductive material (carbon black), and a binder (PVDF, Mw: 700,000±50,000) were mixed at a weight ratio of 95.5:1.5:3 in an NMP solvent to prepare an active material slurry.

The active material slurry was coated onto the primer coating layer to a thickness of 100 μm and dried to form an active material layer, thereby producing a positive electrode.

### Example 2

A positive electrode was produced in the same manner as in Example 1, except that in Example 1, primary particles LiFePO₄ (average diameter (D50): 0.5±0.15 μm), HNBR dispersant (Mw: 220,000±30,000, AN content: 35±3 wt %, RDB 0˜5%), a conductive material (carbon black) and a binder (PVDF, Mw: 700,000±50,000) were mixed at a weight ratio of 88.1:0.9:3:8 in an NMP solvent to prepare a primer slurry, wherein the solid content was set to 45%.

### Comparative Example 1

A positive electrode was produced in the same manner as in Example 1, except that primary particles LiFePO₄ (average diameter (D50): 0.5±0.15 μm), a conductive material (carbon black) and a binder (PVDF, Mw: 700,000±50,000) were mixed at a weight ratio of 95.5:1.5:3 in an NMP solvent to prepare a primer slurry, wherein the solid content was set to 45%.

### Example 3

A positive electrode was produced in the same manner as in Example 1, except that the primer slurry was coated to a thickness of 25 μm, and the active material slurry was coated to a thickness of 80 μm.

### Example 4

A positive electrode was produced in the same manner as in Example 1, except that the primer slurry was coated to a thickness of 10 μm, and the active material slurry was coated to a thickness of 90 μm.

### Comparative Example 2

A positive electrode was produced in the same manner as in Example 1, except that the primer slurry was not coated, and the active material slurry was coated to a thickness of 105 μm.

### Comparative Example 3

A positive electrode was produced in the same manner as in Example 1, except that the primer slurry was coated and dried to a thickness of 105 μm, and the active material slurry was not applied.

### Experimental Example 1

MCMB (mesocarbon microbead), which is artificial graphite as a negative electrode active material, carbon black conductive material, SBR binder and CMC were mixed in a weight ratio of 95.8:0.5:2.5:1.2 in H₂O solvent to prepare a negative electrode active material slurry, which was then applied to a thickness of 65 μm onto a copper foil (thickness: 8 μm) to produce a negative electrode.

A separator of porous polyethylene was interposed between the positive electrode and the negative electrode produced in Examples 1 to 3 and Comparative Examples 1 and 2 as described above to prepare an electrode assembly. The electrode assembly was placed inside a case, and an electrolyte solution was injected into the case to produce a lithium secondary battery. At this time, the electrolyte solution was prepared by dissolving 1.0M concentration of lithium hexafluorophosphate (LiPF₆) in an organic solvent consisting of ethylene carbonate/dimethyl carbonate/ethyl methyl carbonate (mixed volume ratio of EC/DMC/EMC=3/4/3).

Resistance: the lithium secondary battery prepared above was charged up to 4.35V/38 mA at 1C under constant current/constant voltage (CC/CV) conditions at a temperature of 25° C., and then discharged up to 2.5V at 2C under constant current (CC) conditions to confirm the discharge capacity. Next, after charging in the same manner as above, the discharge was performed only by 50% of the previously confirmed discharge capacity. Then, after discharging at 2.5C for 10 seconds, the resistance was calculated using the voltage difference before and after discharge.

High-temperature capacity retention rate (%): the lithium secondary battery prepared above was charged up to 4.35V/38 mA at 1C under constant current/constant voltage (CC/CV) conditions at a temperature of 45° C., and then discharged up to 2.5 V at 2 C under constant current (CC) conditions to measure the discharge capacity. This process was repeated by 1 to 200 cycles. A value calculated by (capacity after 200 cycles/capacity after 1 cycle)×100 was expressed as a high-temperature capacity retention rate (%).

Impact: the lithium secondary battery prepared above was fully charged up to 4.35V/38 mA at 1C under constant current/constant voltage (CC/CV) conditions at room temperature, and then 9.8 kg bar was freely dropped at a height of 61 cm to apply an impact to the cell. When maintained for 1 hour after the impact was applied, it was judged as Pass if the temperature dropped to less than 50 degrees.

Nail penetration: the lithium secondary battery prepared above was fully charged up to 4.35V/38 mA at 1C under constant current/constant voltage (CC/CV) conditions at room temperature, and then nail penetration experiment was performed under GB/T conditions (nail diameter of 3 mm, penetration speed of 150 mm/sec). When maintained for 1 hour after nail penetration, and it was judged as Pass if the temperature dropped to less than 50 degrees.

The measurement results are shown in Table 2 below.

TABLE 2

| | | High- | | |
|---|---|---|---|---|
| | | temperature | | Nail |
| | | capacity | Impact | penetration |
| | Resistance | retention rate | (pass/ | (pass/ |
| | (ohm) | (%) | experiment) | experiment) |
| Example 1 | 1.20 | 94.2 | 3/3 | 3/3 |
| Example 2 | 1.41 | 92.3 | 3/3 | 2/2 |
| Comparative | 1.34 | 93.1 | 2/3 | 1/2 |
| Example 1 | | | | |
| Example 3 | 1.47 | 85.2 | 3/3 | 1/2 |
| Comparative | 1.36 | 88.6 | 3/3 | 2/3 |
| Example 4 | | | | |
| Comparative | 1.18 | 93.9 | 0/3 | 0/3 |
| Example 2 | | | | |
| Comparative | 1.86 | 81.7 | 3/3 | 3/3 |
| Example 3 | | | | |

Referring to Table 2, it can be confirmed that examining Example 1 and Comparative Example 1 according to the present disclosure, by introducing a dispersant, the dispersibility is improved, the resistance is also reduced and the thermal stability is improved, thereby effectively solving the problems caused by impact and nail penetration. Additionally, when the primer coating layer is not formed at all as in Comparative Example 2, it can be confirmed that it cannot pass both the impact and nail penetration tests, so the thermal stability is significantly lowered.

Moreover, when only the positive active material layer is formed using a dispersant as in Comparative Example 3, there is a problem that although the safety is ensured as compared with the case of forming a primer coating layer thinly, the resistance is increased and the amount of active material is relatively reduced, thereby reducing capacity retention rate.

On the other hand, comparing Example 1 and Example 2, when the content of the binder of the primer coating layer increases, the resistance increases and may decrease in terms of capacity, which is more preferably included in an amount of 5 wt % or less.

Additionally, examining Example 1 and Examples 3 and 4, the effect on impact and nail penetration can be confirmed, but when forming a primer coating layer thickly as in Examples 3 and 4, the layer of the positive active material exhibiting high capacity is relatively reduced, while the safety is rather decreased, and thus there is a drawback in that the resistance increases and the capacity retention rate is reduced, and further it is also disadvantageous in terms of energy density.

### INDUSTRIAL APPLICABILITY

As described above, the positive electrode for a lithium secondary battery according to an embodiment of the present disclosure improves thermal stability by applying lithium iron phosphate as a primer coating layer, and at the same time, has an effect of improving energy density by separately applying a positive electrode active material layer containing other lithium transition metal oxides to a substantial capacity.

Additionally, in comparison with the case of applying a primer coating layer containing only a general conductive material, the present disclosure not only has an effect that can contribute to capacity increase by including lithium iron phosphate, but also solves the problem of the lowering of the dispersibility of lithium iron phosphate by adding a small amount of the dispersant, thereby solving the problem of slurry processability caused by the lowering of dispersibility, and effectively exhibiting the performance improvement of the lithium secondary battery, such as electrical conductivity according to the application of the primer coating layer.

Based on the above disclosure, various applications and modifications can be carried out by those of ordinary skill in the art without deviating from the spirit and scope of the present disclosure.

1. A positive electrode for a lithium secondary battery comprising:
a positive electrode current collector;
a primer coating layer disposed on the positive electrode current collector; and
a positive electrode active material layer disposed on the primer coating layer,
wherein the primer coating layer comprises lithium iron phosphate, a binder, a conductive material and a dispersant,
wherein the lithium iron phosphate is represented by the following Chemical Formula 1,
wherein the dispersant is a hydrogenated nitrile butadiene rubber (HNBR), and
wherein the hydrogenated nitrile butadiene rubber is present in an amount of 0.4 to 2.0 wt % based on the weight of lithium iron phosphate
Li₁₊ₐFe₁₋ₛMₛ(PO_{4-b})X_{b} [Chemical Formula 1]
wherein,
M is at least one element selected from Co, Ni, Al, Mg, Ti and V,
X is F, S, or N, and
0≤s≤0.5,
−0.5≤a≤+0.5, and
0≤b≤0.1.

2. The positive electrode for a lithium secondary battery according to claim 1, wherein:
the lithium iron phosphate is composed of primary particles, or is a mixture of primary particles and secondary particles, wherein secondary particles are aggregates of the primary particles.

3. The positive electrode for a lithium secondary battery according to claim 2, wherein:
the primary particles of the lithium iron phosphate have an average diameter (D50) of 0.2 to 3.0 μm, and the secondary particles have an average diameter (D50) of 7 to 25 μm.

4. The positive electrode for a lithium secondary battery according to claim 2, wherein:
the primary particles, or the primary and the secondary particles of the mixture are carbon-coated.

5. The positive electrode for a lithium secondary battery according to claim 1, wherein:
a content of acrylonitrile (AN) in the HNBR is 20 to 50 wt %, and an amount of a residual double bond (RDB) present in the HNBR is 30% or less.

6. The positive electrode for a lithium secondary battery according to claim 1, wherein:
the HNBR has a weight average molecular weight (Mw) of 10,000 to 250,000.

7. The positive electrode for a lithium secondary battery according to claim 1, wherein:
the binder is polyvinylidene fluoride (PVdF) having a weight average molecular weight (Mw) of 500,000 to 1,200,000.

8. The positive electrode for a lithium secondary battery according to claim 1, wherein:
the primer coating layer has a thickness of 1 to 5 μm.

9. The positive electrode for a lithium secondary battery according to claim 1, wherein:
the positive active material layer has a thickness of 50 to 300 μm.

10. The positive electrode for a lithium secondary battery according to claim 1, wherein:
the positive electrode active material layer comprises a lithium transition metal oxide as a positive electrode active material.

11. The positive electrode for a lithium secondary battery according to claim 10, wherein:
the lithium transition metal oxide comprises at least one transition metal selected from the group consisting of Ni, Mn, and Co.

12. A lithium secondary battery comprising the positive electrode for a lithium secondary battery according to claim 1.
